(19) United States
(12) Patent Application Publication
(10) Pub. No.: US 2016/0232608 A1
(43) Pub. Date: Aug. 11, 2016

(54) System for Processing Decomposing Futures Contracts

(71) Applicant: Chicago Mercantile Exchange Inc., Chicago, IL (US)

(72) Inventors: Richard John Stevens, Tonbridge (GB); Joann Arena, Old Bridge, NJ (US)

(21) Appl. No.: 14/616,189

(22) Filed: Feb. 6, 2015

(51) Int. Cl. G06Q 40/04

(52) U.S. Cl. CPC G06Q 40/04

(57) ABSTRACT

Computer systems and methods are provided for processing financial instruments. A combination financial instrument includes a spot delivery financial instrument and a futures financial instrument. The combination financial instrument is decomposed into separate spot delivery and futures financial instruments at a predetermined time.

### FIELD OF THE INVENTION

Aspects of the invention relate to computer implemented systems and methods for processing financial instruments. More particularly, aspects of the invention relate to processing financial instruments that decompose into other financial instruments.

### BACKGROUND

Traders of financial instruments often trade combinations of financial instruments or instruments based on combinations of financial instruments. Financial instruments include equity instruments, bonds, debt instruments, option contracts and futures contracts. One common combination includes the near simultaneous trading of a physical position and an opposing futures position. The physical position may include buying or selling financial instruments for gold, silver, other precious metals or other commodities. The combination of financial instruments allows traders to explicitly trade the price differential and to create hedged positions. While some combinations of financial instruments are desirable, processing orders for such combinations with computer systems creates several challenges.

One approach to processing combinations of orders includes a broker arranging trades for each part of the combination in an off exchange environment. Transactions that occur away from an exchange create challenges relating to monitoring compliance with regulations and rules and ensuring that the best execution has taken place. There is no established method for determining prices of each element of the combination of elements from a single price of the combination of elements.

Another approach involves linking electronic order books hosted at different locations. When order books are hosted at different locations orders may not be filled correctly because of time delays associated with execution of the orders. Moreover, linking order creates a variety of technical challenges.

Accordingly, there is a need in the art for improved systems and methods for processing combinations of financial instruments involving physical elements and futures contracts.

### SUMMARY OF THE INVENTION

Aspects of the invention overcome at least some of the problems and limitations of the prior art by providing systems and methods for processing financial instruments. Efficient computer trading systems and methods are utilized by creating a combination financial instrument that includes a spot delivery financial instrument and a futures financial instrument. At the end of a trading session, or at some other time, the combination financial instrument is decomposed into separate spot delivery and futures financial instruments. A closing price of the futures financial instrument may be used to calculate a price for the spot delivery financial instrument.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a combination financial instrument processed by a financial instrument processing computer system, in accordance with an embodiment of the invention.

FIG. 3 illustrates a computer implemented method of processing financial instruments in accordance with an embodiment of the invention.

### DETAILED DESCRIPTION

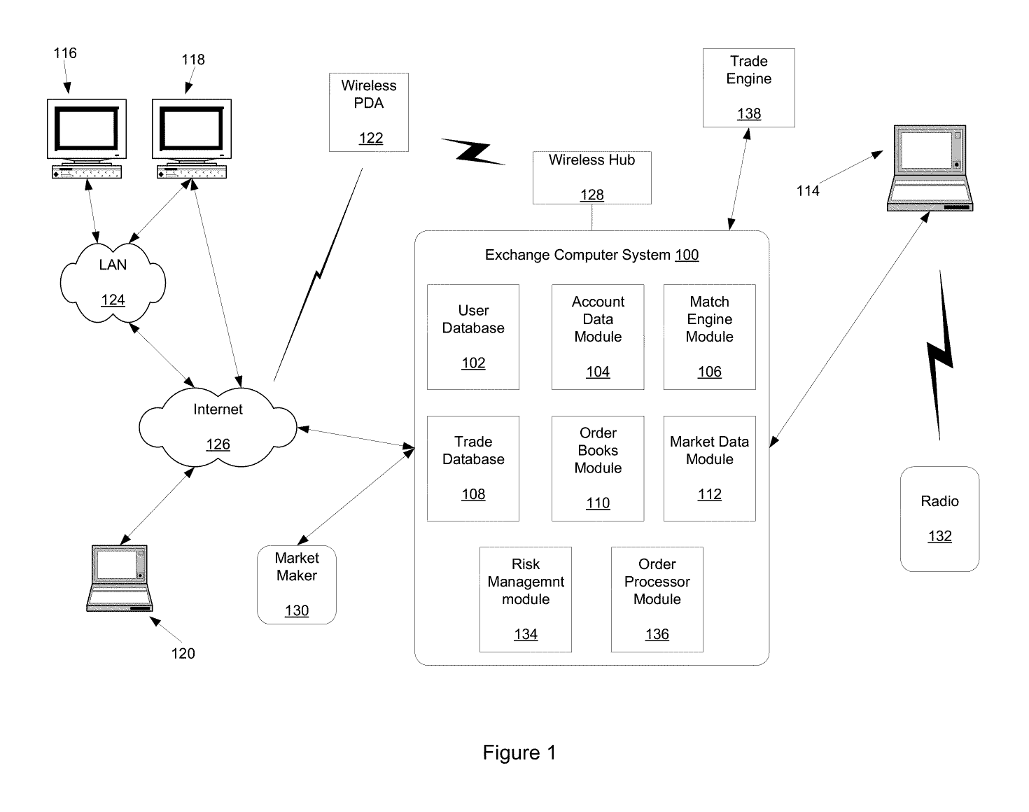

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

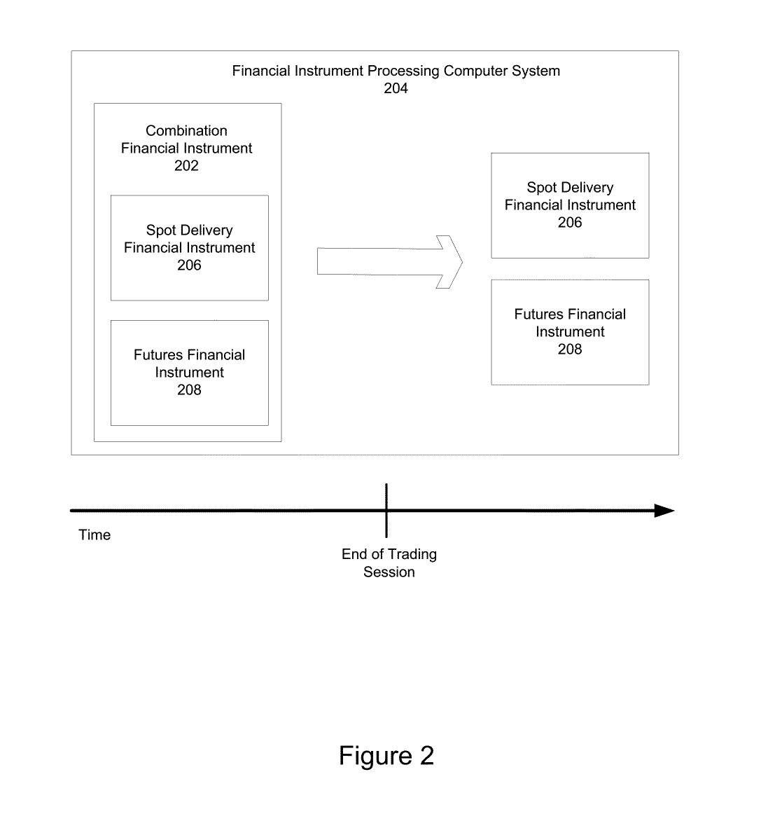

FIG. 2 illustrates a combination financial instrument 202 processed by a financial instrument processing computer system 204 in accordance with an embodiment of the invention. Combination financial instrument 202 may include a spot delivery financial instrument 206 and a futures financial instrument 208. Combination financial instrument 202 may be traded as a single transaction at a single order book and may reduce or eliminate failed order execution risks that exist when multiple orders are attempted to be executed at multiple order books, exchanges or other trading entities. Spot delivery financial instrument may call for the delivery of a commodity such as a precious metal, gold, silver, oil, Treasury securities or other commodities commonly purchased and sold by traders. Futures financial instrument 208 may be a futures contract based on the same commodity as spot delivery financial instrument 206.

Financial instrument processing computer system 204 may be configured to decompose combination financial instrument 202 into separate spot delivery financial instrument 206 and futures financial instrument 208 at a predetermined time, such as at the end of a trading session. Financial instrument processing computer system 204 may include one or more memories that store computer-executable instructions, one or more processors and/or other conventional computer device components. Financial instrument processing computer system 204 may also be configured to communicate with other computer and electronic devices, such as the devices shown in FIG. 1.

Financial instrument processing computer system 204 may be operated by an exchange or other trading entity that will distribute market data for combination financial instrument 202 to provide transparency. Of course, an exchange or other trading entity may provide market data with other computer systems.

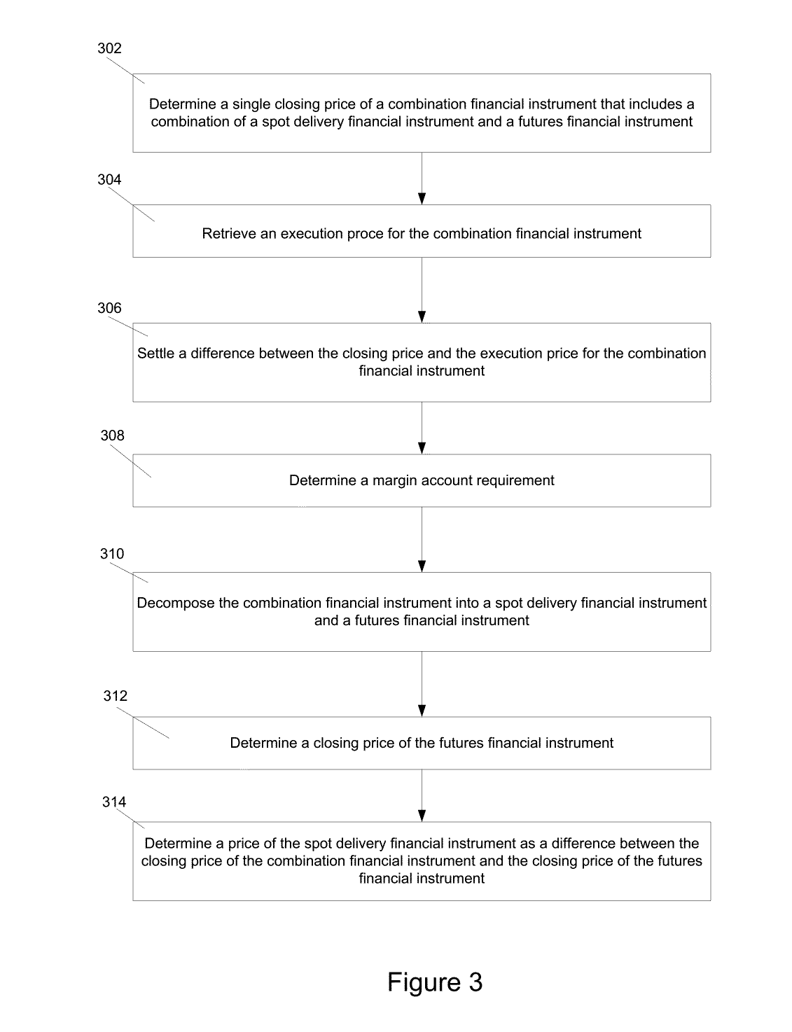

FIG. 3 illustrates a computer implemented method of processing financial instruments in accordance with an embodiment of the invention. The process may be used to process combination financial instruments, such as combination financial instrument 202 (shown in FIG. 2). The combination financial instruments may be traded at an exchange or other trading entity. Some or all of the steps shown in FIG. 3 may be implemented with computer systems executing computer-readable instructions that are stored in one or more tangible memory devices.

First, in step 302 a single closing price of a combination financial instrument is determined. The combination financial instrument includes a combination of a spot delivery financial instrument and a futures financial instrument and may have been listed for trading at an exchange or other trading entity. The closing price may be determined after a trading session has ended and may be determined by a committee or a computer system configured to determine closing prices. Next, an execution price for the combination financial instrument is retrieved in step 304. The execution price is the price at which a trader purchased or sold the combination financial instrument. The execution price may be retrieved from a memory.

Next, in step 306 accounts may be settled after determining a difference between the closing price and the execution price for the combination financial instrument. Step 306 may be performed by a clearing house computer system or other computer system. After a trading session has ended, margin account requirements may be determined in step 308. Step 308 may include requiring and account holder to deposit an additional amount of money or may include reducing an amount required to be maintained in a margin account.

After the end of a trading session and prior to the beginning of a subsequent trading session, in step 310 the combination financial instrument may be decomposed into a spot delivery financial instrument and a futures financial instrument. Step 310 may include creating spot delivery financial instrument 206 and futures financial instrument 208 and assigning long and short positions to traders of spot delivery financial instrument 206 and futures financial instrument 208. In alternative embodiments step 310 may be performed during a trading session.

In some embodiments, the purchase of combination financial instrument 202 may correspond to a purchase of spot financial instrument 206 and a sale of futures financial instrument 208. In other embodiments, the purchase of combination financial instrument 202 may correspond to a sale of spot financial instrument 206 and a purchase of futures financial instrument 208. Step 310 may include decomposing combination financial instrument 202 accordingly.

Steps 312 and 314 may be used to determine prices of spot delivery financial instrument 206 and futures financial instrument 208 and may be performed by one or more exchange computer systems or other computer systems and may be performed after the ending of a first trading session and prior to the beginning of a subsequent trading session. In step 312 a closing price of futures financial instrument 208 is determined. Step 312 may include receiving a market data feed from a futures exchange. In step 314 a price of spot delivery financial instrument 206 is determined as a difference between the closing price of the combination financial instrument 202 and the closing price of the futures financial instrument 208.

The steps shown in FIG. 3 allow computer systems to transparently and efficiently process financial instruments. The use of a combination financial instrument reduces or eliminates execution risks that exist when multiple match engines or exchanges are used. The use of a combination financial instrument also reduces complex networking connections that may otherwise be required to link discrete match engines or exchanges. Programming a computer device to determine prices of financial instruments that were components of a combination financial instrument between trading sessions also optimizes the use of computing resources. Trading a single combination financial instrument also facilitates monitoring compliance with rules and regulations.

The present invention has been described in terms of preferred and exemplary embodiments thereof. Numerous other embodiments, modifications and variations within the scope and spirit of the invention will occur to persons of ordinary skill in the art from a review of this disclosure.

We claim:

1. A computer implemented method comprising:
(a) determining a single closing price of a combination financial instrument that includes a combination of a spot delivery financial instrument and a futures financial instrument;
(b) retrieving from a memory an execution price for the combination financial instrument;
(c) settling at a computer processor a difference between the closing price and the execution price for the combination financial instrument;
(d) decomposing the combination financial instrument into a spot delivery financial instrument and a futures financial instrument;
(e) determining a closing price of the futures financial instrument; and
(f) determining at a computer processor a price of the spot delivery financial instrument as a difference between the closing price of the combination financial instrument and the closing price of the futures financial instrument.

2. The computer implemented method of claim 1, wherein the spot delivery financial instrument calls for the delivery of a commodity and the futures financial instrument is based on the same commodity.

3. The computer implemented method of claim 2, wherein the spot delivery financial instrument calls for the delivery of a precious metal.

4. The computer implemented method of claim 3, wherein the spot delivery financial instrument calls for the delivery of gold.

5. The computer implemented method of claim 3, wherein the spot delivery financial instrument calls for the delivery of silver.

6. The computer implemented method of claim 3, wherein the spot delivery financial instrument calls for the delivery of oil.

7. The computer implemented method of claim 3, wherein the spot delivery financial instrument calls for the delivery of a Treasury security.

8. The computer implemented method of claim 1, wherein (c), (e) and (f) occur after completion of a first trading session and before the start of a next trading session.

9. The computer implemented method of claim 1, wherein (a), (c), (e) and (f) occur after completion of a first trading session and before the start of a next trading session.

10. The computer implemented method of claim 1, wherein the combination financial instrument is based on a sale of the spot financial instrument and a purchase of the futures financial instrument.

11. The computer implemented method of claim 1, wherein the combination financial instrument is based on a purchase of the spot financial instrument and a sale of the futures financial instrument.

12. The computer implemented method of claim 1, further including determining a margin account requirement after (c).

13. A system comprising:
a memory containing computer-executable instructions;
a processor configured to retrieve the computer-executable instructions from the memory and that when executed cause a computer device to perform the steps comprising:
(a) determining a single closing price of a combination financial instrument that includes a combination of a spot delivery financial instrument and a futures financial instrument;
(b) retrieving from a memory an execution price for the combination financial instrument;
(c) settling at a computer processor a difference between the closing price and the execution price for the combination financial instrument;
(d) decomposing the combination financial instrument into a spot delivery financial instrument and a futures financial instrument;
(e) determining a closing price of the futures financial instrument; and
(f) determining at a computer processor a price of the spot delivery financial instrument as a difference between the closing price of the combination financial instrument and the closing price of the futures financial instrument.

14. The system of claim 13, wherein the spot delivery financial instrument calls for the delivery of a commodity and the futures financial instrument is based on the same commodity.

15. The system of claim 14, wherein the spot delivery financial instrument calls for the delivery of a precious metal.

16. The system of claim 15, wherein the spot delivery financial instrument calls for the delivery of gold.

17. The system of claim 16, wherein the spot delivery financial instrument calls for the delivery of silver.

18. The system of claim 13, wherein (c), (e) and (f) occur after completion of a first trading session and before the start of a next trading session.

19. A tangible non-transitory computer-readable medium containing computer executable instructions that when executed cause a computer device to perform the steps comprising:
(a) determining a single closing price of a combination financial instrument that includes a combination of a spot delivery financial instrument and a futures financial instrument;
(b) retrieving from a memory an execution price for the combination financial instrument;
(c) settling at a computer processor a difference between the closing price and the execution price for the combination financial instrument;
(d) decomposing the combination financial instrument into a spot delivery financial instrument and a futures financial instrument;
(e) determining a closing price of the futures financial instrument; and
(f) determining at a computer processor a price of the spot delivery financial instrument as a difference between the closing price of the combination financial instrument and the closing price of the futures financial instrument.

20. The tangible non-transitory computer-readable medium of claim 19, wherein the spot delivery financial instrument calls for the delivery of a commodity and the futures financial instrument is based on the same commodity.
